(19) United States
(12) Patent Application Publication
(10) Pub. No.: US 2002/0003697 A1
(43) Pub. Date: Jan. 10, 2002

(54) OUTDOOR LIGHTING WITH ORGANIC EL ELEMENTS

(76) Inventor: TSENG-LU CHIEN, TAIPEI HSENG (TW)

Correspondence Address: HOWARD C. MISKIN, C/O STOLL, MISKIN, HOFFMAN & BADIE, EMPIRE STATE BUILDING, 350 FIFTH AVE., STE. 6110, NEW YORK, NY, 10118, US

(21) Appl. No.: 09/305,653

(22) Filed: May 5, 1999

(51) Int. Cl. F21V 9/16

(52) U.S. Cl. 362/84

(57) ABSTRACT

A outdoor lighting with Organic Electro-luminescent elements powered by Direct-Current (D.C.) connect with battery, solar, transformer, generator can supply super brightness from TENS to Hundred-Thousand(s) candle power persquare meter to be visible under bright enviroment for outdoor lighting MAY selection from desired group consideration of Garden light, Patio Light, House Number, Step Stone, Accent Light, for House Use. Furtherly can offer Commercial Light & Public-Safety Light applications which may including, Barricade Light, Delineator Light, Traffic Sign, Pavement Light, Warning Sign, Traffic Light, becon light, street sign, highway sign, Ramp light, with variety Molecular, Partical, layers, film, ink treatment with proper arrangement toget desired cost, effeects to improving outdoor lighting brigtness by Organic EL which do not need any Alternatic Current form to get illumination.

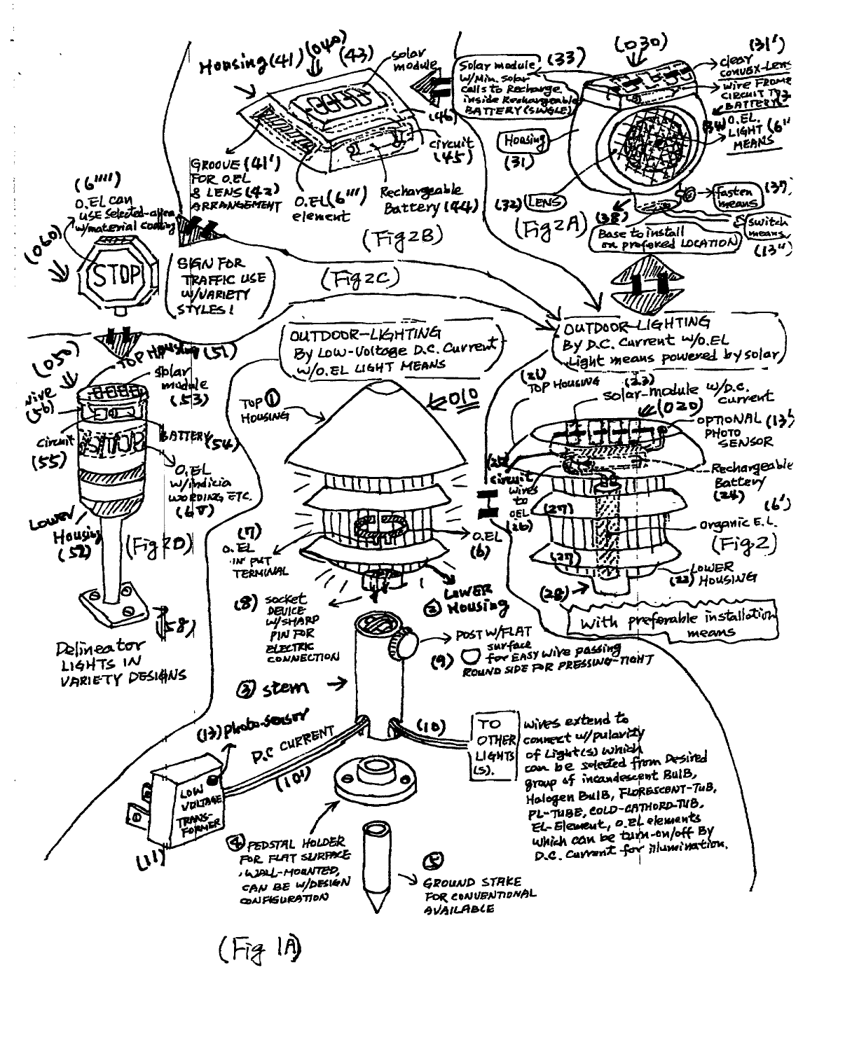

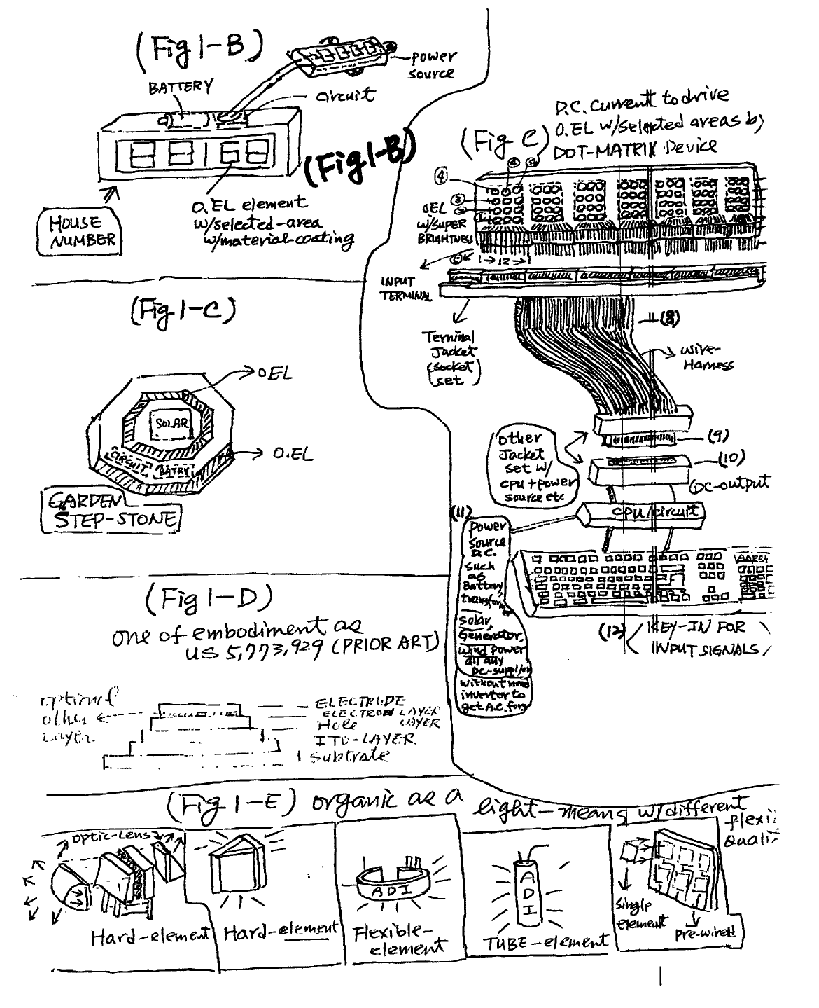

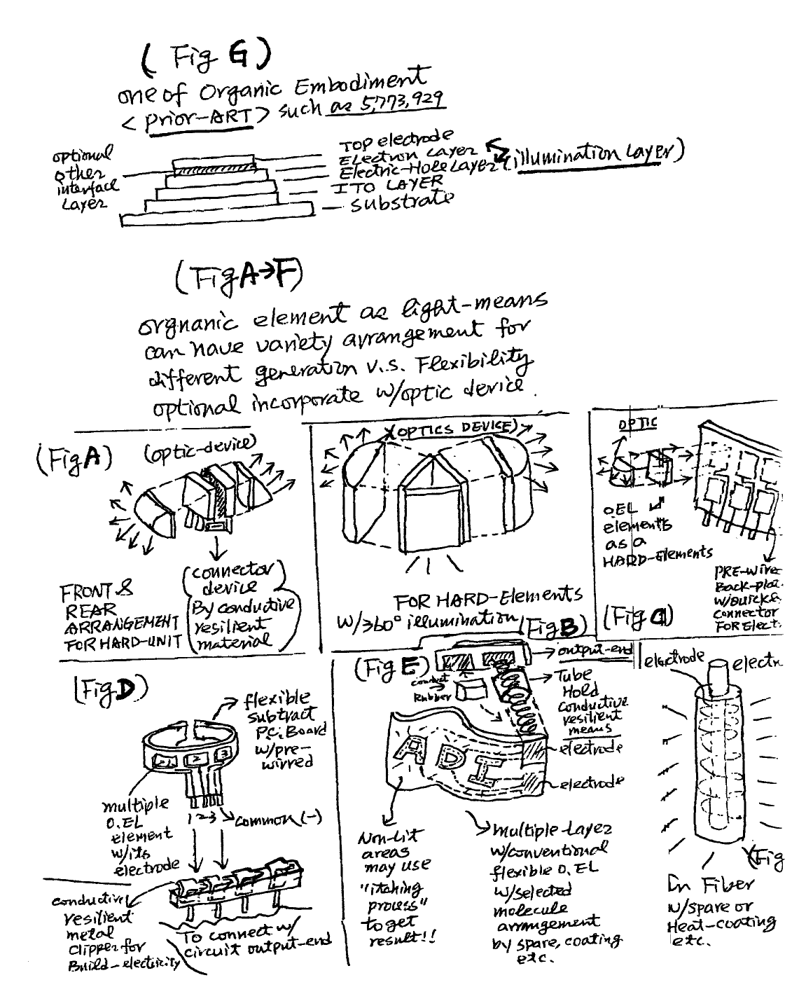

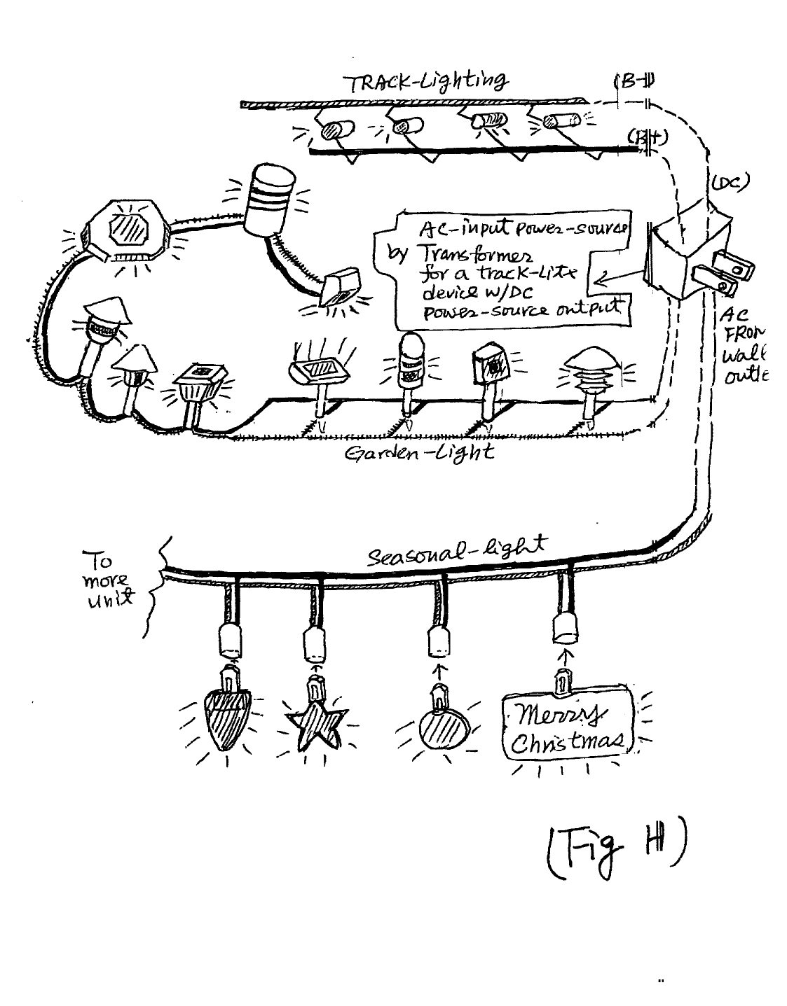

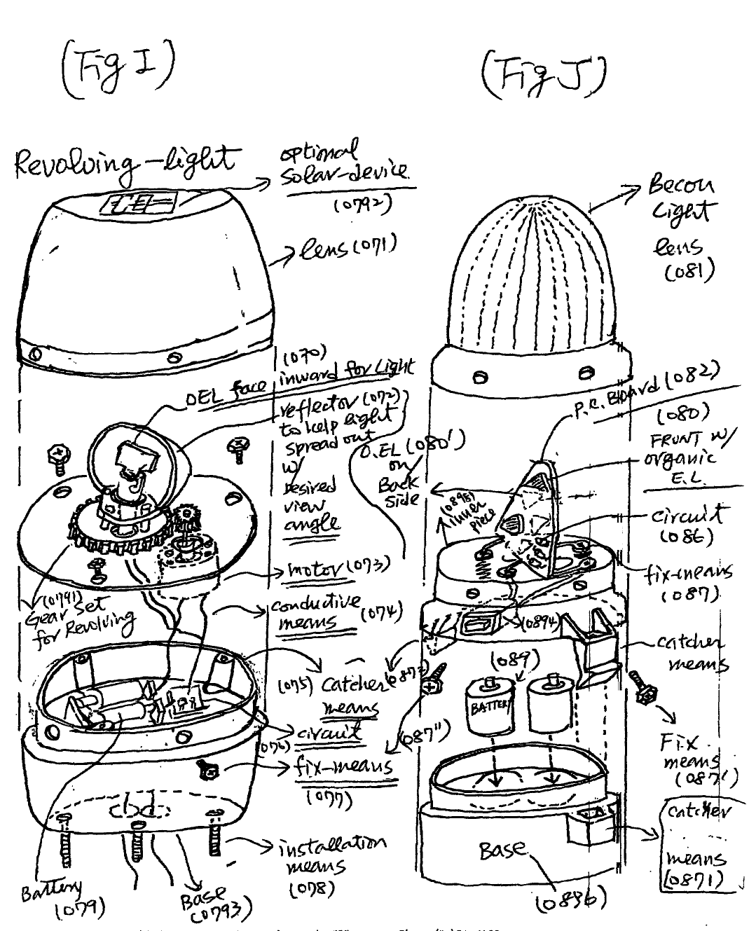

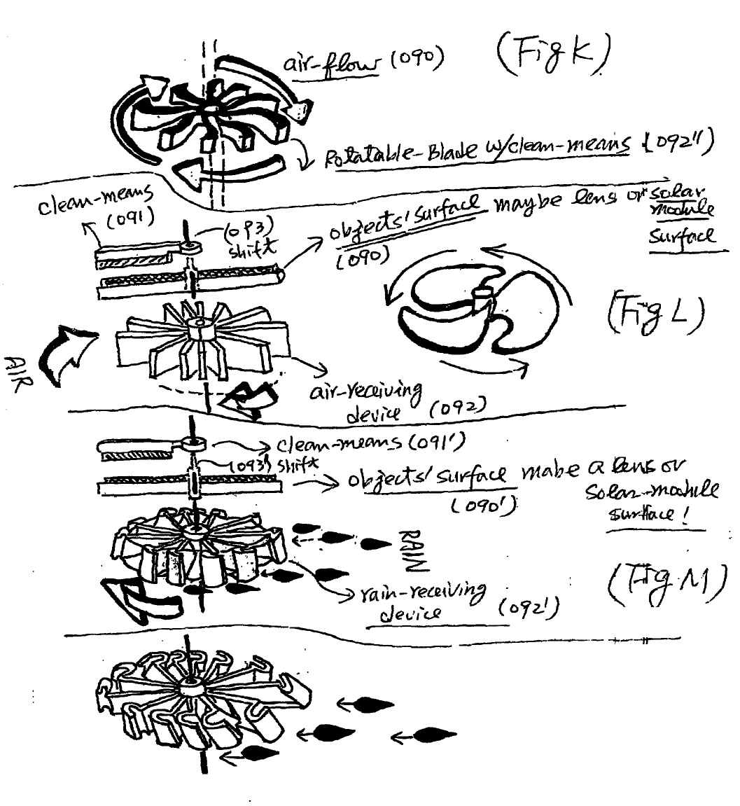

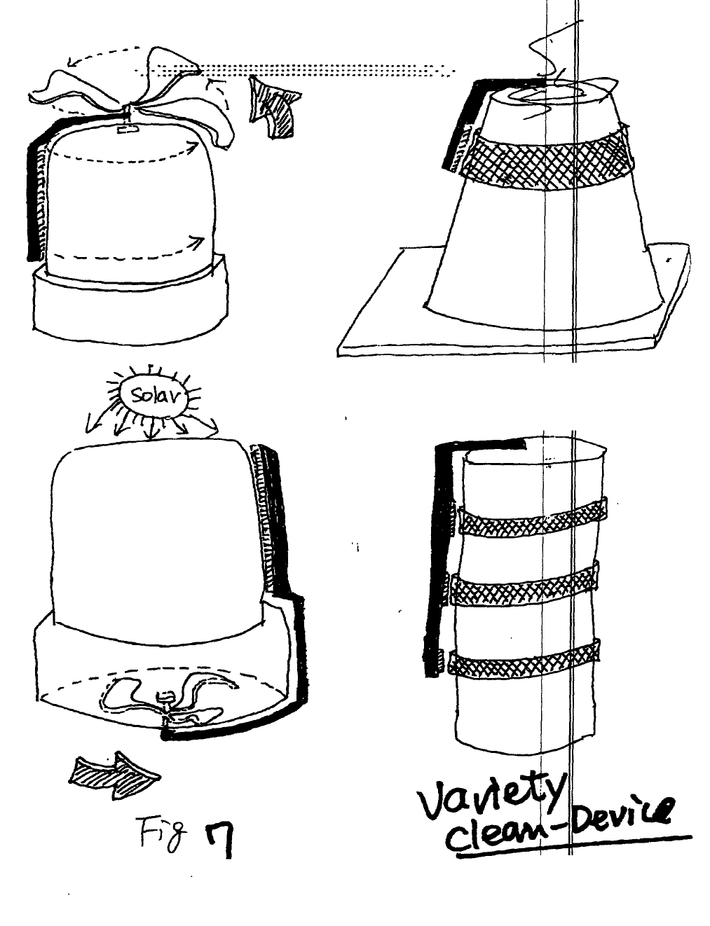

### BACKGROUND

(1) This is a CIP filing by inventor of its U.S. Pat. No. 5,806,960issued on Sep. 15, 1998 which prior art diclosure a UNIVERSALSAFETY LIGHT (Battery powered Lighting) with traditional Electro-Luminescent element powered by battery which incorporated by Invertor device by transformer, inductor, IC to change DC Power Source into a Alternative Current form with prefered voltage and frequency to trigger Traditional EL elemets to emitted light though some area to see the light.

(2) The Inventor also teached the Selected Areas with Electro-luminescent partical coating on different layers to form a EL lamp in shape of Panel, Strip, Tube etc on his U.S. U.S. Pat. Nos. 5,772,817-5,752,337-5,794,366-5,833,508-5,469,342 which have selected area(s) with lit-area may made by cut-out, opening, window, masking, stencil, filter, film, silkscreen, painting, of particle, spray, ink, layers, films, coating, vacume vaporized, heat vaporized treatment to get purpose. With such proper treatment so can hvae lower cost for manufacture and accepted by public of this EL technical for variety lighting.

(3) Especially the U.S. Pat. No. 5,469,342 teached a discreted particals coating on different layers and the selected area(s) with light emitted out for cost saving . . . . However, The Organic EL elements mainly is use the electron and electric hole to form a illumination layer(s) instead of Traditional EL elements with phospher particles by coating, spray apply to the layers have big theory different. Hence, The Organic EL may have much much brighter than Traditional EL elements.

Even, This patent also disclosure the applications for SHOE, GLOVE, TRAFFIC CONE, CAP, HEADGEAR which have double patent under (4) U.S. Pat. No. 5,479,325 FOR HEADGEAR with EL elements but all have low-brightness can not compare with Organic EL element which have 10 to 10,000 times or MORE Than this number of the brightness over than invertor type with extra cost free for non-invertor required.

(5) The inventor also teached a OUTDOOR GARDEN LITE by a Neon Tube (Different Light means) with Current EL as light means as his U.S. Pat. No 5,504,397 issued on Apr. 2, 1996.

(6) The inventor also teached some SOLAR POWERED GARDEN LITE as its U.S. DES. 309,785-309,786-309,787-309,954 and SOLAR POWERED TILE 309.953. However, all these light using a incadescent light with super big power consumption so the cost for Batteries & Solar Charge need very big power with expensive cost to build such unit. Hence, These program are not practicle for such expensive device in market place. As for SOLAR POWERED CONSTRUCTION LITE under U.S. DES. 333,797 issued on Mar. 9, 1993 which have more big problem because this is a PUBLIC SAFETY LIGHTING which need more couldy weather consideration for up to 21days with every night for 8 hours so using the Incandescent is too big power comsumption so not practicle. It also have very difficult to use Light Emitted Diode basing on too narrow viewing angle & The limited colors which can not meet USA standard so this is a very difficult and can not become practical products.

(7) The Inventor other U.S. Pat. No. 5,722,760 teached use a Traditonal Electro-Luminescent Elements with REMOVEABLE DOT-MATRIX Device which can easily replacement the Defected EL elements. However, This is have more cost involved than a SILKSCREEN DOT MATRIX by EL . . . . Especially for some application do not need to have a life-time garantee for such items. Hence, The Cost Consideration and Simple Manufactur will be big concern . . . .

(8) U.S. Pat. No. 5,566,384 issued date Oct. 15, 1996 VEHICLE WITH EL light . . . . All Warning light such as Collision Avoidance Light, Rear light Assembly, Interior light, Door light, Courtesy light, head-line light device all light use a traditional EL element which have unsufficient light brightness to meet market requirement so need enlarge size which too costly, The ONLY SOLUTION is use a non-invertor, non-Alternatic Current Organic EL for these application with 10-100 times brighness with all other existing EL featrues to improve low brightness.

(9) U.S. Pat. No. 5,720,651 issued on Feb. 24, 1997 which teached a FLYING DEVICE with EL elements with Invertor deivce but It same result the brightness is too low not practical so the changing to Organic with Non-Invertor required +10 to 100 times brighness increase will be very good for this applicaiton.

(10) Furthlery, Inventor his U.S. Pat. No. 5,451,842 teach a SEASONAL LIGHT kits with EL elements which also use a Traditional EL elements which have to use a invertor to incorperated in order to get HIGHER VOLTAGE and HIGHER FREQUENCY to get qualified light brightness but this is can be improved simple by a Organic Electro-Luminescent Element which only need a Direct-Current so no extra cost for Invertor.

The Organic Electro-Luminescent Element with same super thin thickness, Flexible, Lower power consumption (Colse to Light Emiited Diode), The most important is IT CAN BE DRIVE BY DIRECT-CURRENT (D.C.) and SUPER BRIGHTNESS (Traditional is less than Hundred Candle Power per square meter . . . . O.EL elements have from HUNDREDS TO THOUSAND without need Alterantic Current requirement) . . . . Hence, For vareity Application such as aboved mentioned OUTDOOR LIGHTING, UNIVERSAL SAFETY LIGHTING, TRAFFIC LIGHTING, SEASONAL LIGHT, DOT MATRIX LIGHTING, COMMERCIAL LIGHTING can have traditonal EL-Element all features with COST SAVING for non-invertor required +non-Alternatic Current required . . . . BUT with over 10 to 100 times brightness.

The Organic EL element which may selected from marketing available type by different process, material, lamination, coating, vacume spray, vacume coating or other treatment to get different features such as softness, bending curvature, brighness, color(s), kelvin temperatures Color analysis) or other specification such as US prior arts for different process which show on following or future patents for methord to making Organic EL elements . . . . The US prior arts such as U.S. Pat. Nos. 5,882,761-5,858,560-5,792,557-5,773,929-5,684,365-5,635,308-5,620,806-5,616,427-5,508,136-5,500,568-5,306,572-5,107,175-5,093,691-etc. etc. for conventional marketing availble type with different features not limited for using for the outdoor lighting application as current invention discussed below.

The current invention use Organic Electro-luminescent Elemement for Garden light, House-Number, Season Light, Traffic Light, Delineator Light, Barricade light, Traffic Sign, Dot MatriX Lighting, Moving Vehicles lighting, Commericial light, Headgear Battery Operated Light, Flying device, Portable Battery Operated lighting will up-grade to a super brightness (INCREASE 10-100 TIMES BRIGHNTNESS) without Invertor needed (Cost Saving) reduce risk of electric shock (Only DC current instead of AC current at 100V AC) . . . . These features are qualify to make a up-grade improvement for all above mentioned Inventor's patent filing.

### DETAILS DISCRIPTION

From Fig (G), this is a prior-art which is one of the organic Electro-luminescent Element(s) constructure as aboved discussed serveral US patents. From this constructure can simple know the Organic EL MAY have a substrate base with upper of a ITO layer (or other conductive layer as one of electrode). Top of the Conductive layer is a Illumination layer which may consist of Electron and Electric-hole layer with proper arrangement). Top of illumination layer are the Top conductive electrode. While the DC current applied to the lower and top electrodes . . . . The electron and electric-hole make impact to emitted the super brightness which may up to 140,000 (Brand is Pioneer) candle power/persquare meter with half life with 80,000 hours. This kind of Organic Electro-luminescent light also perfect for the Traffic lighting becuase the Response time is less as 600 ns (brand is Idemitsu) which is not Light Emitting Diode can compare with for Auto and Traffic light so this will be qualified by Traffic safety than other light means. It also have following features as: Viewing Angle: 180degree Screen Brightness: Min. 100 cs/sq meter Emission Efficiency: 16 lm/w Contrast Ratio: Super High. Driving Power: Direct Current Panel Thickness: within 2 mm or less (depend vendor) Operation Temperature: −40 to +90 degree However, The technical is fast developing, we did not limited for certain specification as above listed. The current invention mainly for using such super brightness for all kind of outdoor lighting so can improving the power consumption, no electric shock (because is D.C.) no temperatures occured (No fire harzard) so this is most suit for any outdoor lighting as following discription with details discussion.

Fig (A) to Fig (F), Explain all kind of the Organic Element arrangement with different softness for bending with desired terminalsarrangemetn with proper electric connection though a media-means to circuit output end(s). Also, the variety organic Element(s) in different form and configuration depend on the manufactures development and available type from the market place. (here did not discuss with details basing on details marking on the drawing by wording for better understanding from drawing (A) to (F).

From FIG. (1A) diclosure a low-voltage powered garden light (010) with a quickly electric-power connecting system with organic EL elements (6) as a replaceable light means to offer a super brightness, multiple color illumination for garden. the low-voltage light (12) mainly use a AC to DC tranfromer (11) to get electricity to carry by electric wire (10′) to the one of garden light and passing into stem (3) and to the top location crossing the post (9) and come down to stem (3) lower portion with opening with wire (10) extend to other multiple of lights (not show). The wire (10) may bave hundreds to thousand feets so can offer the same electricity power to others multiple light and all light(s) are arrange in parelle circuit so each one have same power and can connect at anywhere. the stem (3), Pedstal holder (4) or Ground Stake (5) can be in any configuartion to allow the light to install anywhere on outdoor such as ground, patio, wall, fence, sand, idea location so allow people satify.

The power source as tranformer (11) offer a typical Direct-Current so can allow Organic EL (6) can be trun on without any expensive invertor-device help. Hence, the cost will pretty saving. The Wire (10′) go to upper end of stem (3) and hold by post (9) which have round and flat surface which are allow wire can be easily install on post (9) while use flat surface, while need to connect with top Pin (14) can simple twist post (9) with some angle so the pin (14) will break wire (10′) skin and get electric cotact with inner cooper wire. The O.EL element (6) have a termianls which get the electrode(s) from layer and form a preferable terminal type allow people can quickly replacement this O.EL elements (6) at any time required. The Terminal at this embodiment is can be snap-into the two metal socket set which will tight contact with terminals (14) so build up the electric connection from OEL (6) electrodes to terminal to socket set (8) and bottom of socket sets with two pins (14) so to inserted into wire (10′) to get electrical connection to turn on OEL (6) for prefered brightness. A optional circuit such as simple photo sensor (13) can arrange on the transformer (11) for turn on/off. Alterantively the timer or other electric circuit can apply to this light kits for desired light function as conventional market (did not diuscuss here). By using a O.EL (6) as a easily replacement light means with super tiny space needed and super thin, fliexible, super lower power consumption (close to Light Emitted Diode), super brightness (from hundreds to thousands candle power/per square meter), multiple color selection, super good enviroment resistance, cold light without any temperature existing while turn on a long time, Direct Current for trigger current form all these features will improve all defects for the current market incandescent bulb type which is fragile, big power consumption, heat-surface temperature, fire harzard etc. Hence, Using a O.EL as a Outdoor lighting light means will have a great advantage as above mentioned.

Furtherly, From Fig (H) can see other application more clear (Do not make marking becaue simple to read wording from drawing for report) . . . . The One Transformer get electricity from Wall outlet which is a Alternatic Current which are changed into a Direct Current so allow to apply to Organic Electro-luminescent element(s) though a media-means such as a buss-line(s) in paralle connection methord (may use other arrangement). The Top can see the track-light arrangement for outdoor applications. The center shows a lot of different configration of garden light kits with Organic EL element(s) or other D.C. light means from the common buss-line(s) . . . . From the lower drawing can see the outdoor Seasonal light set with socket with Organic light elements which with desried shapes to apply to the common buss-line(s) for illumiation and it can be changeable for different organic-kits while different season.

Frther, Basing on Organic EL is drived by a Direct Current so it can be work with some unlimited power source which may selected from any combination of solar, wind, water incorporated the Battery or Batteries, Capacitor to make the light with good light performance under bad season with month cloudy weather consideration. From FIG. (2) a Solar power Outdoor lighting (020) which haveing a top housing (21) which have 4 pcs solar cells to form a solar system which can charge internal Single Rechargeable battery (24) though a circuit (25) to controll the solar system output voltage & current into battery and controll the timing when battery (24) will supply electricity to O.EL (6′) for illumination. Furtherly the circuit can have some “Voltage Rasing Design” to allow people to reduce the expensive solar cell(s) number so the output from solar system will be LESS THAN the MININUM voltage (around 0.484per cell ×2pcs=0.97 V) to charge internal Rechargeable battery (such as 1.4 Volt) and Circuit Voltage Drop (0.3 to 0.6 V) . . . . The additional circuit which will raise the solar system output 0.97 V to OVER (1.4 V+0.6V=2.0V) By conventional market circuit may use INDUCTOR, Transformer which will convert the 0.94 V solar output voltage to a higher voltage to allow battery is recahrged without any problem even for more higher voltage for CLOUDY WEATHER consideration so the solar system will charge battery even under bad light enviroment . . . . This will be great for helping solar become more reliable power source especially for some PUBLIC SAFETY items. This will be discussed on following paragraphy.

From FIG. (2) the solar system (23) is made out 4 pcs which around have 0.484V×4=1.936 V which is too much to overcome than single battery 1.45V & overcome circuit voltage drop 0.3V=1.75 V, so it is too much. From aboved discussion the low cost version can use 2 pcs solar cell to get solar system (23) which will save a big cost and labor and get 0.484×2=0.97 Volt plusing the circuit help so it will easily to get the voltage before charge battery will up to 1.80V or higher depend on the market requirement and cloudy weather consideration. Solar system (23) with desired output into circuit (25) without reverse leakage battery power from battery into solar so the battery (24) is been charged during day time and power is stores inside battery (24). At the time need light to turn on the circuit (25) will start to allow battery (24) power though circuit (25) though wire to allow OEL (6′) to turn on. The Organic EL (6′) are well arrange inside the lower housing (22) for some enviroment protection. The Solar system (23), optional photo-cell (13′), battery (24), Circuit (25), Wire (26) and OEL's attachment means( not show) may install on top housing (21) and assembly with lower housing (22) by conventional means for security assembly . . . . The some installation means such as stem (3), Pedstal holder (4), Ground Stake (5) or wall mounted bracket, Fence Mounted bracket and hardware all can use same drawing as FIG. (1A) or selected from marketing available model. The solar powered outdoor lighting is not a brand new concept but there is no any solar power outdoor lighting with Oganic EL element which drive by DC current form, Also there is no any prior art disclouse a solar system's output voltage-level which MUCH LESS than BEEN CHARGED ITEMs' voltage level and use unexpesive circuit to make-up arrangement.

Also O.EL element supre wide viewing angle which same as incandescnet bulb function which Light Emitting Diode can not do the same . . . . As for Brightness, The O.EL have hundreds to thousands candle power per square meter will much brighter than Flourescent, cold cathord, Light Emitting Diode under same power consumption level . . . . Hence, The Direct Current O.EL panel is the best light means for outdoor lighting.

From FIG. (2-A) is the 2nd embordiment in a design of SOLAR BARRICADE LIGHT (030) which have all same theory with identical compoments such as housing (31), Lens (32), Top Clear conex lens (31′), solar system (33), Wire (36) to Circuit (35) to Battery (36) with O.EL elements (6″) behind the lens (32) with replaceable termianl by quickly connecting device and with Base (38) to allow install barricade light on post, barricade, fence, wall, ground, or other place which needed. The switch means can be a two wire (13″) which prevent any light kits with fully charged and power waste during delivery. The switch means for turn on/off light daily while dust can use solar system (33) have lower voltage or low current as a signal to make a switch function accordingly by circuit design . . . . the “Clear convex lens (31′)” mainly for get better light receiving surface also allow the water or rain can clean the solar lens automatically prevent from dust, sand, oil to accumulated on these areas with flat surface design. The Lens (32) as normal battery power barricade light have to meet US standard.

The FIG. (2-B) which is in the form of a pavement light which can be a temperoty or permerment device for public safety. The Solar pavement light (040) is install on flat surface such as the Road or any Flat surface especially for dangerous curved turns and country road. The unit with Metal housing (41) with center hollow to allow installsolar system into a super strong Poly carbonated tray into a metal housing (41) and a OEL light means (6″″) are behind a enviroment sealing groove (41′) for getting light emitted out with wide viewing angle though durable lens (42) and super brightness light beam can be visible from the side or side(S) . . . . The battery (44) and circuit (45) and wire (46), and installation means (not show) are all the same as Light (010) (020) (030) not disucss here again.

The FIG. (2-C) same as FIG. (2) (2-A) (2-B) but this is one of the traffic sign (060) which including any existing sign for public to use for direction, warning, indication, limitation, street name, street number etc. The Sign (060) with O.EL use seletcted-areas with material coated to show out the S-T-O-P to save cost as Inventor's U.S. Pat. Nos. 5,572,817-5,752,337-5,794,366-5,833,508 disclosured incorporated with solar system and battery (not show), circuit (not show) inside housing for public use . . . . These sign have variety shape and wording for offer people some message for safety, indication, direction etc.

FIG. (2-D) is another Outdoor lighting with O.EL (6 V) with design, indicia, logo, wording incorporated with solare system (53), wire (56), circuit (55), battery (54) inside the top housing (51) and with prefered attachment with lower hosing (52) which ahve the base (58) for install on idea location for people know the delineation with super bright O.E.L light means, It may also can be in a traffic cone which with same platc cylinder or tube type.

More Outlight with O.EL also can easily found for application like house Number like FIG. (1-B) or garden Step-stone (1-C) all can have low-voltage light power source or unlimited power source from solar, wind, generator etc . . . . Also like Fig (I) which is powered by a traditional battery (079) which have its circuit (076) to offer the OEL (070) & Motor (073) with desired functions. The Gear set (079′) for Revolving and OEL (070) are install on the reflector (072) to help the small OEL (070) have a wider viewing angle. A multiple conductive means (074) are connected with OEL (070), Motor (073), Circuit (076) to offer the electric signal(s) to each other from Battery (079) which may be a replaceable type or a rechargeable type which may be powered by Solar, Wind, Genertor for unlimited power for convenient and enviroment concern. This light will be have a supre brightness by OEL (070) with very lowre power consumption like Light Emitting Diorde(s) But with super big viewing angles. The alternative models as Fig (J) which have a becone light lens (081) though a number of catcher means (0871) (0872) to connect with base (0896). The Organic EL elements some install on one side of Printing circuit board (082) such as (080) and other piece install reverse side (080′). The fix means (087) and (087′) (087″) allow the inner plate (0898) fixed to the base (0896) . . . . The circuit (not show) are connected with battery (089) and a switch (0894), Multiple piece of OEL (080), (080′) by conductive means for desired light function(s) . . . . This becon light also can incorporated with “Nature Clean Device” or “unlimted power source” as aboved discussed. All these light is typical for outdoor lighting for Garden, Traffic, Sign with message or logo, indicia with stencil, masking, printing, or material coating on layers to get desired effects with super brightness+Wide Viewing Angle+Flexable+Supre thin+Good Enviroment all features which non of any marterial will have more good than O.EL as this patent disclosured.

Furthe more, the MOTION MESSAGE SIGN also easily to apply O.EL as light means becuase it is use a Direct Current to drive so can use all marketing available circuit & CPU to get the same effects. For Example for DOT MATRIX design dicuss following:

FIG (C) discouse a DOT MATIX arrangment by a O.EL elements within a limited space. The selected area with particles coating with certain space as drawing is a DOT MATRIX with 7 sections and each section with 3×4 Dot Matrix which are selected area with O.EL material coated on different layers.

As inventors' prior arts disclosure on U.S. Pat. Nos. 5,572,817+5,5,752,337+5,794,366+5,83,508+5,469,342 with details discription so do not have ditails discuss for this. However, Thee have some special arrangement for the Current DOT Matrix (Different with Removeable EL for iventor's U.S. Pat. No. 5,722,760) for electrode(S) arragement for SILKSCREEN DOT-MATRIX TYPE.

The current Fig (c) use silkscreen process to make a pre-wiring of electrodes on different layers . . . . The Prefereable arrangement are use a COMMON 1st electrod of each individual lit-area (DOT) on the CONDUCTIVE LAYER or ITO layer so this layer can have selected area(s) coating togatherly . . . . The 2nd electrode of each individual lit-area (Dot) have to well arrangement to buttom of SECTION (12 pcs of #5 terminals).

Line 4—3 Dots' Electrodes to Buttom Area

Fig (C) can easily to see the 1st line have 3 pcs #1 electrode can easily to print conductive material to #5 terminal area because most close to the lower bottom area to form the 3 pcs terminals.

Line 2—3 pcs of DOTs' Electrodes to Bottom

However, The 2nd Line also have 3 pcs of electrodes have to be arrived Bottom area to form the terminals to get electric signal to turn on/off these dots. but there have no extra space can allow the 3 pcs #2 electrodes passing though line1 lit-area (DOT), so the only way is to make “JUMP WIRE” which need to use <1st DIELECTRIC-COATING PRINTING TOP OF all Line 1 covered all conductie materials>. This covered by 1st Extra direlectric-layer so the LINE 2 (3 pcs of Dots' electrodes can print conductive material on TOP of this 1st EXTRA Dielectric layer to reach the Bottom area to form 3 pcs of Terminals so have 6 termianls on bottom now.

LINE 3—Have 3 pcs Dots' Electrodes to Bottom Area

The Way to make Line (3) 3 Dots electrodes to lower buttom, Need to print <2nd Extra Dielectric layer on to cover all line 2 dots>, so the conductive material can printed and jump to line 2 and reach to buttom area to form the another 3 termianls total now is 9 termainals on bottom.

Line 4—have 3 dots' Electrodes to Buttom Area

Again, the (3rd Dielectric layers need applied to cover the line 3 conductive material well ), so can printed conductive material for line 4 electrodes to bottom area to get another 3 terminals on bottoms area, now total is 12 termianls.

These “Jumping Wire” arrangement is different with marketing type of LED DOT MATRIX becuase this embordiment with a COMMON 1st electrodes which is on another coating layer . . . . There have a lot of alternative way can do this JUMP WIRE arragement but we did not disucss all variation arrangement. However, The multiple dots (or other shapes) within a tiny space have to have a certain numbers of EXTRA DIELECTRIC LAYERS and Conductive Layers coating to get the good arrangement . . . . This is not similar with traditonal EL manufacturing process which not necessary.

From Fig (C) can easily while 1st Section 12 Dots have its own 2nd electrode's terminals on bottom area with common 1st electrodes on desired position. These terminals for total 7 sections will be have 12×7=84 terminals . . . . These 84 terminals all belong to 2nd electrode of each dot . . . . The terminals can in the form of Contact-Area type, Metal-Clamp Type, Glue-Ribbom Type, Rivet-Contact type or other marketing type for better design and assembly methord . . . . All 84 terminals will be use (10) adaptor device to get electric connection with CPU system or You can have the (7) adaptor to OEL terminals and passing though wire (8) and (9) (10) adaptor device then connect with CPU system . . . . The CPU system can with all kinds light effects with pre-program the each dot(s) turn on/off timing, duration, color, brightness so the DOT MATRIX become a message board to offer desired message, indicia, wording, drawing, logo with desired ligth effects by super brightness, super power saving OEL material.

The OEL itself also can have all features as inventor's U.S. Pat. No. 5,722,760 issued on Mar. 3, 1998 for multiple color, Multiple unit form a Small Unit and use Unit(S) to form a section. Multiple Section into a desired board.

The CPU system can use the marketing available type without any INVERTOR device so It is very cost saving for R&D and Mass Production because can get any LED or Bulb CPU system to drive OEL without need AC current at all . . . .

The Power source for the Direct Current can be get from Battery, Transfromer, Generator and get sufficient power from Solar, Wall outlet electricity, Car Generator, Spin Generator or Wind Generator, Water Generator or equivelent power source . . . . As long as the OEL receive Direct Current to allow it turn on/off with desired timing, duration, brightness, color etc.

Furtherly, The outdoor lighting can incoporated with a Nature Powered Clean system as Fig (L) to clean the dust, oil, bird's shit, or other material attached on the Lit-area's lens or solar module surface . . . . The nature powered means from the wind, air (092), rain (093), snow to make the some shift-assembly (093) (093′) to rotating to move the “Clean means” (091) (091′) to clean the object's surface (090) (090′) as the Fig (K), Fig (L), Fig (M).

Of course the outdoor lighting should designed these important surface such as solar module suface. lit-area len's surface, the retro-reflective lens with propoer shape in order to can clean by rain and snow is necessary to if do not have such Nature Powered Clean means. The clean means also can have rubber-blade like automobile windshield type with super light weight to attached on the desired ligh weight arm so can make rotating and touch the lens while the cars passing by . . . . This can be easily to achieve from conventional market. The Air-Receiving Device may be also workable for Rain-receiving device or snow-receiving device etc . . . .

This is mainly use a SILKSCREEN PROCESS to get a message changeable Light device because O.EL is 10 to 100 times brighter than traditional EL so finally this can work under the DAY LIGHT for outdoor use.

Furtherly, the outdoor lighting with O.EL can incorporated with any kinds of light means as a second or third light means to get special effects and extra function like camping light with flourescent+incandescent light. The multiple light means source to incorporated the O.EL as co-pending filing of Ser. No. 09/158,503 and Ser. No. 09/220,368 which have more features than single light means especially the EL material with super low power consumption to allow battery life can extend multiple times so this is a good features.

There have a lot of other outdoor lighting disclosure by same inventor for above Cap Light, Flying device, Moving Vehicles lighting, Universal Safety Light, Flashlight, Portable light, Camping light, Navigation light, Headgear light, Backpack light, Seasonal Light etc which can offer people to use for outdoor installation or outdoor activities with desired illumination for people to be visible . . . . Hence, O.EL apply to such lighting will increase a lot of brightness with non-invertor requirement to get lower cost which it is very practicle than other light means as this patent disclosure, BUT DO NOT LIMITED FOR THIS ASPECT FOR OTHER LIGHTING FOR OUTDOOR INSTALLATION, ACTIVITIES in personal, alived animal, traffic sign, traffic light, moving vehicle light, portable light or equivelent to offer illumination to people should cover inside this patent disclosure.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

1. As U.S. Pat. No. 5,722,760 patent disclosure DOT-MATRIX, The EL element can use a Direct Current to drive a Organic Electro-liminescent Element(s) instead of Alternative Current from any Invertor device.

2. AS U.S. Pat. No. 5,451,842 patent disclosure SEASONAL LIGHTING, The EL elements can use a DIRECT CURRENT TO DRIVE Organic Electro-Luminescnet element(s) instead of Alterantive Curreent from any invertor device.

3. As U.S. Pat. No. 5,504,397 patent disclousre NEON GARDEN LIGHT, The NEON TUBE can use a DIRECT CURRENT TO DRIVE Organic Electro-Luminescent element(s) instead of Alternative Curent from any invertor device.

4. As U.S. Pat. No. 5,479,325 patent disclosure HEADGEAR WITH EL ELEMENTS, The EL elements can use a Direct Current To Drive Organic Electro-Luminescnet element(s) instead of Alterantive Current from any invertor device.

5. As U.S. Pat. No. 5,469,342 Patent Disclosure Light Strips with EL elements, The EL elements can use a Direct Current to Drive Organic Electro-Luminescent element(s) instead of Alternative Current from any invertor device.

6. As U.S. Pat. No. 5,566,384 patent Disclosure VEHICLES WITH EL ELEMENTS, The EL elements can use a Direct Current to Drive Organic Electro-Luminescnet Element(s) instead of Alterantive Curretn from any invertor device.

7. As U.S. Pat. No. 5,720,651 patent Disclosure FLYING DEVICE with EL elements, The EL elements can use a Direct Current to Drive Organic Electro-Luminescent Element(s) instead of Alernative current from any invertor device.

8. As U.S. Pat. No. 5,806,960 patent disclosure, UNIVERSAL SAFETY LIGHT with EL Elements, The EL elements can use a Direct Current to Drive Organic Electro-Luminescent Element(s) instead of Alterantive Current From any Invertor Device.

9. As US Des. 309,785 or 309,786 or 309,787 or 309,954 SOLAR LIGHT can incorporated with any kinds of EL elements inducing using a Direct Current to Drive Organic Electro-Luminescent Element(s).

10. As US Des. 333, 797 Solar Construction Light can incorporated with any kinds of EL elements including using a direct current to drive organic electro-luminescet element(s).

11. A Outdoor Light Apparatus with Organic Electro-Luminescent (O.EL) element(s) Drived by a Direct Current which from the power srouce may selected from any combination of BATTERY, SOLAR, TRANSFORMER, GENERATOR, WIND, WATER, ROTATING.
At a least one housing for parts on desired arrangement to allow O.EL light emitted out can be visible.
At least one of installation means to allow housing to install on proper location.

12. A outdoor lighting apparatus with O. EL element(s) as claim 11 . . . . The main Object MAY selected from any group combination of Garden Light, Solar Power Outdoor Light, Portable Battery Operated Light, House Number, Patio Light, Accent Light, Traffic Light, Traffic Sign, Delineator Light, Traffic Cone light, Pavement Light, Barricade light, Flashlight, Camping light, Vehicles Interior Light, Vehicle Collision Avoidance Light, Vehicles Rear light Assembly, DOT Matrix Sign, Commerical Sign, Seasonal Light, Headgear Light, Universal Safety Light, Flying device with EL light, Shoe Light, Glove light and lighting for OURDOOR INSTALLATION, ACTIVITIES light device.

13. A Outdoor Lighting with Organic EL element(s) as claim 11 . . . . Futherly incorporated with a circuit to controll the electric signal to turn on/off Organic EL element(s) under predetermined condition for prefered light effects, duration, color, brightness as marketing available design.

14. A outdoor lighting with organic EL elemement(s) as claim 11 . . . . Organic EL can have selected area(s) with particles coating on different layers.

15. A outdoor lighting with organic EL element(s) as claim 11 . . . . Organic EL can have selected area(s) with particles coating on multiple layers including extra dielectric material layer(s) so to form a Jump-Wire result to have a multiple conductive-wire within a limited space applied for DOT-Matrix pre-wiring arrangement.

16. A outdoor lighting with organic EL element(s) as claim 11 . . . . The O.EL can have prefered terminals such as Rivit, Clamp, Pin, Plug, Ribbom or equivelent terminals to easily solder, press-tight contact, snap-tight contact in order to connect with electric signals to turn on elements for illumination.

17. A outdoor lighting with organic EL element(s) as claim 11 . . . . The O.EL element may having mutliple lit-area(s) with respectly electrodes connected with terminal. All terminals may selected from coated terminal, metal terminal, conductive resilient material terminal with desired configuration to connect with electric-signal(S).

18. A outdoor lighting with organic EL element(s) as claim 11 . . . . The O.EL a lot of electrodes for each of selected lit-area(s) which having common 1st-electrode on one O.EL element.

19. A outdoor lighting with organic EL element(s) as claim 18, The common 1st-electrode can use conductive-material's coating on layer to make this arrangement.

20. A outdoor lighting with organic EL element(s) as claim 16 . . . . The terminals arrangement also allow O.EL panel can be easily replacement while needed.

21. A outdoor lighting with organic EL element(s) as claim 11 . . . ., the outdoor lighting is a low voltage power garden light which can get Direct Current from Transformer system.

22. A outdoor lighting with organic EL element(s) as claim 11 . . . . The Outdoor lighting is a garden lighting which can get Direct Current from battery or batteries which can be supplied power from power source selected from Solar, Wind, Generator or chemical, nuclear which have unlimited power be created under physics theory.

24. A outdoor lighting with organic EL element(s) as claim 11 . . . . The Outdoor lighting is a Moving Dot-Matrix Sign which having a CPU controll system, Scan system to allow each individual dot(s) be trun on/off under predetermined timing, brightness, color with desried ligth effects may selected from marketing place.

25. A outdoor lighting with organic EL elements(s) as claim 11 . . . . the Outdoor lighting is a vehicle lighting device for interior or exterior application to allow people see the Organic light which are powered by Direct Current without need Alternative current form.

26. A outdoor lighting with organic EL element(s) as claim 11 . . . . The outdoor lighting is a portable light apparatus which for people to carry may be in a form of Flashlight, bike light, headgear lighting, shoe light, vest light, belt light, Flying device light, key chain light, ID pass light, badge light for people to use for illumination of safety and commerical, advertisement purpose.

27. A outdoor lighting with organic EL element(s) as claim 11 . . . . the outdoor lighting is a seasonal lighting for all kinds of holiday and seasonal purpose.

28. A outdoor lighting with organic EL element(s) as claim 11 . . . . the outdoor lighting is for road construction light or public safety light device may in the form of Barricade light, Delineator light, Pavement light, Traffic Sign, Traffic Light, Warning Sign, Direction Sign, Marking Sign, Distance sign, Exit Sign etc. for Public Road user to know the condition for safety guider purpose.

29. A outdoor lighting with organic EL element(s) as claim 28, the outdoor light may incorporated with some unlimited power source selected from solar, generator which can combined with wind, water, temperturs to supply DC current for application.

30. A outdoor lighting with organic EL elemet(s) as claim 11 . . . . The outdoor light powered by unlimited power source from solar which have a number piece of solar cell(s) arranged to get voltage output equal to Mininum Voltage required to charge SINGLE batteriy & overcome the circuit voltage drop while charging.

31. A outdoor lighting with organic EL element(s) as claim 11 . . . . the outodoor light having a unlimited power source by solar which having a number of solar cell(s) arranged to get voltage output LESS than Mininum voltage required to charge battery (batteries) and overcome curcuit voltage drop while charging, The Solar output voltage are rasied by a simple Inductor, trasformer, converter or conventional circuit to get higher voltage to have good charging system under any kind of light condition may included cloudy weather.

32. A outdoor lighting with organic EL element(s) as claim 11 . . . . the outdoor lighting with unlimited power source from Solar which may selected from armophose type or crystall type for desired output from solar system.

33. A outdoor lighting with organic EL element(s) as claim 11 . . . . outdoor lighting powered by unlimited power source from solar which can use solar system voltage or current value to become a switch to save cost for following switching system including manual switch, timer switch, photo sensor switch, on/off switch.

34. A outdoor lighting with organic EL element(s) as claim 11 . . . . The ourdoor lighting powered by unlimited power source from solar can have a clean system which use wind to drive a fan-arms with rubber blade to clear the surface of light bean receiving surface or light emitting out surface so the light having a shelf-clean system.

35. A outdoor lighting with Organic EL element(s) as claim 11 . . . . the outdoor lighting powered by unlimited power source by solar which the Organic EL element(s) is a easily replacement compoments to allow people can replace it at any time needed.

36. A outdoor lgihting with Organic EL element(s) as claim 11 . . . . The Outdoor light means may incorporated with other light means may selected from incandescnet bulb, flouresent tube, cold cathord tube, halogen bulb, mercury lamp, or traditional EL elememt(s) for additional features.

37. A outdoor lighting with Organic EL element(s) as claim 11 . . . . The Outdoor Lighting with tranformer which get Electricity Outlet from wall and change from Alternative Current (AC) to Direct Current (DC) and can offer the Outdoor lighting for multiple light units which may have combination with other light means such as EL-elements (AC TYPE), Incandescent bulb, gas filled bulb, Halogen Bulb, Mecury vapor light, Light Emitted light, conventional light-means for desired combinations for a outdoor lighting device for desired purpose.

38. A outdoor lighting with organic EL element (s) as claim 37, It means the Outdoor lighting can have at least one Organic Light device with at least one OTHER light means device from Transformer type power source(s).

39. A outdoor lighting with organic EL element(s) as claim 38, T he outdoor light device may also incorporated with a Solar Power souce instead of transformer type.

40. A lighting with organic EL element(s) as claim 38 . . . . The light device with Multiple piece at least one is organic light elements which may also in a form for a “Track lighting” which are in series or in parelle for connect with the output end of transformer so can get electricity to turn on multiple lights device from a common electricity for electrode.

41. A outdoor lighting with organic EL element(s) as claim 40, The light device for track-light may apply under the roof or outside the roof.

42. A outdoor lighting with organic EL element(s) as claim 40, The light device connet with transformer output ends by a conventional electricity connection methord.

43. A outdoor lighting with organic EL element(s) as claim 11 . . . . The Outdoor light may in a form for track lighting with a common electrodes connection with buss electrode to trigger with desried function.

44. A outdoor lighting with organic EL element(s) as claim 43, the common buss electrode electricity carrier maybe use a thin material may selected from electric wire, conductive material, metal tunb, conductive layer, conductive film so save extra cost basing on lower power consumption, no electric shock harzard, heat problem.

45. A outdoor lighting with organic EL element(s) as claim 11 . . . . the outdoor light may have its configuration design for market requirement.

46. A outdoor lighting with organic EL element(s) as claim 11 . . . . the Organic may have all kind of front sheet such as masking, stencil, cut-out, window, transparent film, painting, coating, lamination, sticker, silkscreen, block out, cover, illumination layer, conductive layer, particle (electric particle & electric-hole) arrangement to form a selected area(s) illumination appearance and effects.

47. A outdoor lighting with organic EL element(s) as claim 11 . . . . The circuit may incorporating with power souce to get desired light function(s) from marketing available type.

48. A outdoor lighting with organic EL element(s) as claim 11 . . . . The Organic Electro-Luminescent Element(s) may selected from marketing available type with desried constructure and softness.

49. A ourdoor lighting with organic EL element(s) as claim 11 . . . . The Organic Element(s) may incorporating with Optics Members which can get from 10 to 360 degree for viewing angle.

50. A outdoor lighting with organic EL element(s) as claim 11 . . . . The Organic Element(s) may have its proper terminal for most quickly and simple connection with circuit output ends.

51. A outdoor lighting with organic EL element(s) as claim 50 . . . . connection with circuit otuput ends may though a conductive resilent member such as in form of spring, conductive rubber, conductive wire, conductive layer, conductive metal clipper, conductive resilent metal plate, or the like for same function piece(s).

52. A outdoor lighting with organic EL element(s) as claim 50, for the multiple organic EL elemets terminals connect with circuit output end may use Liquid Crystal Display Conductive rubber for Multiple electrode(s) connection with simple pressing type.

53. A outdoor lighting with Organic El element(s) as claim 52 . . . . the multiple electrodes connection may also incorporated with computer wire harness arrangment by clipper, receptacle sets means.

54. A outdoor lighting with Organic EL element(s) as claim 11 . . . . The Outdoor light may incorporated with Nature Powered Clean device to clean the object's surface.

55. A outdoor lighting with organic EL element(s) as claim 54, The object surface may be is a solar module surface, Light's lit-area surface, retro-reflective area's surface so clean all dust, oil, flying object's dirty things or the like.

56. A ourdoor lighting with organic EL element(s) as claim 54, the nature power means the air, wind, snow, rain, heat.

57. A outdoor lighting with organic EL element(s) as claim 11, the outdoor light may incorporated with motor, movement, sound, Chemical, Electronic, Mechanical means to get some extra function(s) to make light more practiclly.

58. A outoor lighting with organic EL element(s) as claim 11 . . . .

59. A outdoor lighting with organic EL element(s) as claim 11 . . . .

60. A outdoor lighting with organic EL element(s) as claim 11 . . . .
